(19) United States
(12) Patent Application Publication
(10) Pub. No.: US 2026/0150824 A1
(43) Pub. Date: Jun. 4, 2026

(54) FISHING DEVICE WITH MULTIPLE LEVERAGE SEGMENTS

(71) Applicant: Ricky Fusillo, Tequesta, FL (US)

(72) Inventor: Ricky Fusillo, Tequesta, FL (US)

(21) Appl. No.: 19/378,581

(22) Filed: Nov. 4, 2025

Related U.S. Application Data
(60) Provisional application No. 63/716,484, filed on Nov. 5, 2024.

(51) Int. Cl. A01K 87/08; B25G 1/10

(52) U.S. Cl. CPC A01K 87/08; B25G 1/102

(57) ABSTRACT

A device for use in fishing designed to provide a user multiple hand positions, thus offering multiple leverage sections when reeling in a fish. The fishing device with multiple leverage segment provides multiple leverage sections made of one or more series of bends, curves, angles, or combinations; therefore, where the leverage sections are integrally formed from or part of the overall device or as an attachment to a separate instrument used for fishing.

### CROSS REFERENCE

In accordance with 37 C.F.R. 1.76, a claim of priority is included in an Application Data Sheet filed concurrently herewith. Accordingly, the present invention claims priority to U.S. Provisional Application No 63/716, 484, entitled “FISHING DEVICE WITH MULTIPLE LEVERGE SEGMENTS”, filed on Nov. 5, 2024. The contents of the above referenced application are incorporated herein by reference in its entirety.

### FIELD OF THE INVENTION

Embodiments of the invention are directed towards a device used for fishing; to an improved fishing device with multiple leverage segments; and more importantly, to a fishing device designed to provide multiple holding positions, thus offering multiple leverage segments when reeling in a fish.

### BACKGROUND OF THE INVENTION

Over the last several years, the number of individuals fishing continues to increase, with an estimated number of 57.7 million Americans getting out on the water to enjoy fishing. Regardless of the type of fishing, i.e. saltwater, freshwater or fly fishing, having the proper equipment is critical, not only to enjoy the activity but to be successful in catching fish. One of the critical types of equipment is that of a fishing rod. In its simplest configuration, a fishing rod is nothing more than an elongated pole with fishing line attached. While a fishing rod can get very elaborate given the linear structure, the number and/or the location where a person can place his/her hands is limited.

### SUMMARY OF THE INVENTION

Embodiments of the invention are directed towards a device, such as a fishing rod or fishing pole, for use in fishing designed to provide a user multiple hand positions, thus offering multiple leverage segments when reeling in a fish. The fishing device with multiple leverage segments provides multiple leverage sections made of one or more series of bends, curves, angles, or combinations therefore, where the leverage segments are integrally formed from or part of the overall device, or as an attachment configured to secure to a separate fishing instrument.

In certain embodiments, a fishing device compromises an elongated pole or rod; and a leverage unit, the leverage unit comprising multiple leverage points which a user can grab or rest their hand thereon, the leverage unit off-set from the longitudinal axis of the elongated pole or rod. The leverage unit may comprise a plurality of segments sized and shaped for gripping. The fishing device may comprise of the leverage unit having a plurality of adjacent segments or surfaces wherein each adjacent segment is oriented in different direction. Each adjacent segment may be separated by an angle.

In certain embodiments, the invention may provide for a leverage device for attaching to a fishing pole or rod, comprising: a first end having a first fishing device engagement member; a second end having a second fishing device engagement member; and a body separating the first end and the second end, the body comprising multiple leverage points which a user can grab or rest their hand thereon. The leverage device body may comprise a plurality of segments or surfaces. The leverage device according to body may comprise multiple adjacent segments, wherein the multiple adjacent segments are separated by an angle.

Accordingly, it is an objective of the invention to provide an improved fishing device, such as a fishing rod or fishing pole, for use in catching fish.

It is a further objective of the invention to provide a fishing device, such as a fishing rod or fishing pole, for use in catching fish that provides multiple points of leverage.

It is yet another objective of the invention to provide a fishing device, such as a fishing rod or fishing pole, for use in catching fish that provides multiple off-set or off-center leverage segments.

It is a still further objective of the invention to provide a fishing device, such as a fishing rod or fishing pole, for use in catching fish that provides multiple off-set or off-center leverage segments made of one or more bends.

It is a further objective of the invention to provide a fishing device, such as a fishing rod or fishing pole, for use in catching fish that provides multiple off-set or off-center leverage segments made of one or more series of bends.

It is yet another objective of the invention to provide a fishing device, such as a fishing rod or fishing pole, for use in catching fish that provides multiple off-set or off-center leverage segments made of one or more series of curves.

It is a still further objective of the invention to provide a fishing device, such as a fishing rod or fishing pole, for use in catching fish that provides multiple off-set or off-center leverage segments made of one or more series of angles.

It is a further objective of the invention to provide a fishing device, such as a fishing rod or fishing pole, for use in catching fish that provides multiple off-set or off-center leverage segments made of one or more series of bends, curves, angles, or combinations therefore.

It is yet another objective of the invention to provide a fishing device, such as a fishing rod or fishing pole, for use in catching fish that provides multiple off-set or off-center leverage segments made of one or more series of bends, curves, angles, or combinations therefore, where the leverage segments are integrally formed from or as part of the overall device.

It is a still further objective of the invention to provide a fishing device, such as a fishing rod or fishing pole, for use in catching fish that provides multiple off-set or off-center leverage segments made of one or more series of bends, curves, angles, or combinations therefore, where the leverage segments are a securable add-on structure.

It is a further objective of the invention to provide a fishing device, such as a fishing rod or fishing pole, for use in catching fish that provides multiple off-set or off-center leverage segments made of one or more series of bends, curves, angles, or combinations therefore, where the leverage segments provide a user multiple hand positions to pull the fishing rod or fishing pole towards them with greater leverage.

It is a further objective of the invention to provide a fishing device, such as a fishing rod or fishing pole, for use in catching fish that provides multiple off-set or off-center leverage segments made of one or more series of bends, curves, angles, or combinations therefore, where the leverage segments are made of different lengths.

It is yet another objective of the invention to provide a fishing device, such as a fishing rod or fishing pole, for use in catching fish that provides multiple off-set or off-center leverage segments made of one or more series of bends, curves, angles, or combinations therefore, where the leverage segments are defined by various numbers or series of bends, curves, angles, or combinations therefore.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1A is a perspective view of an illustrative embodiment of a fishing device with multiple leverage segments;

FIG. 1B is a perspective view of the fishing device with multiple leverage segments shown in FIG. 1A, illustrating embodiments of various degrees of angulation relative to each other (adjacent segments) or the main body;

FIG. 2 is a perspective view of an illustrative embodiment of a fishing device with multiple leverage segments;

FIG. 3A is an embodiment of the fishing device with multiple leverage segments, illustrated as an independent structure which is added and/or secured to a fishing device;

FIG. 3B illustrates the optional use of a clip placed in the gap of a second fishing device engagement member;

FIG. 4 is an embodiment of the fishing device with multiple leverage segments, illustrated as an independent structure which is added and/or secured to a fishing device;

FIG. 5 is an embodiment of the fishing device with multiple £ leverage segments, illustrated as an independent structure which is added and/or secured to a fishing device;

FIG. 6 is an embodiment of the fishing device with multiple leverage segments, illustrated as an independent structure which is added and/or secured to a fishing device;

FIG. 7 is an embodiment of the fishing device with multiple leverage segments, illustrated as an independent structure which is added and/or secured to a fishing device;

FIG. 8 is an embodiment of the fishing device with multiple leverage segments, illustrated as an independent structure which is added and/or secured to a fishing device;

FIG. 9 is an embodiment of the fishing device with multiple leverage segments, illustrated £ as an independent structure which is added and/or secured to a fishing device;

FIG. 10 is an embodiment of the fishing device with multiple leverage segments, illustrated as an independent structure which is added and/or secured to a fishing device;

FIG. 11 is an embodiment of the fishing device with multiple leverage segments, illustrated as an independent structure which is added and/or secured to a fishing device;

FIG. 12 is an embodiment of the fishing device with multiple leverage segments, illustrated as an independent structure which is added and/or secured to a fishing device;

FIG. 13 is an embodiment of the fishing device with multiple leverage segments, illustrated as an independent structure which is added and/or secured to a fishing device;

FIG. 14 is an embodiment of the fishing device with multiple leverage segments, illustrated as an independent structure which is added and/or secured to a fishing device;

FIG. 15A illustrates a fishing rod with an embodiment of the fishing device with multiple leverage segments, illustrated as an independent structure, secured thereto;

FIG. 15B illustrates an alternative view of the of the fishing rod shown in FIG. 15A;

FIG. 15C illustrates an alternative view of the of the fishing rod shown in FIG. 15A;

FIG. 15D illustrates an alternative view of the of the fishing rod shown in FIG. 15A;

FIG. 16 is a close-up view of the fishing rod shown in FIGS. 15A-15D, illustrating the engagement of the first fishing device engagement member;

FIG. 17 is an alternative close-up view of the fishing rod shown in FIGS. 15A-15D, illustrating the engagement of the first fishing device engagement member;

FIG. 18 is a close-up view of the fishing rod shown in FIGS. 15A-15D, illustrating the engagement of the second fishing device engagement member;

FIG. 19 is an illustrative embodiment of the placement of a fishing reel;

FIG. 20 illustrates alternative placements of the fishing reel; and

FIG. 21 illustrates alternative placements of the fishing reel.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

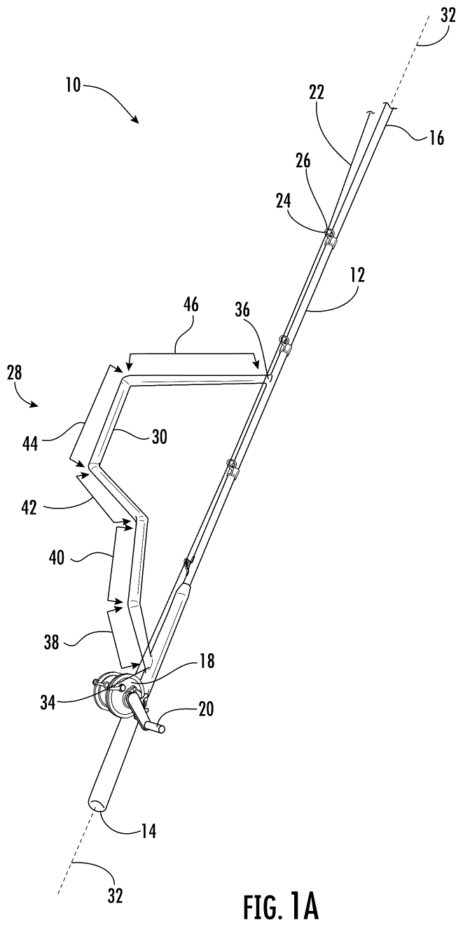

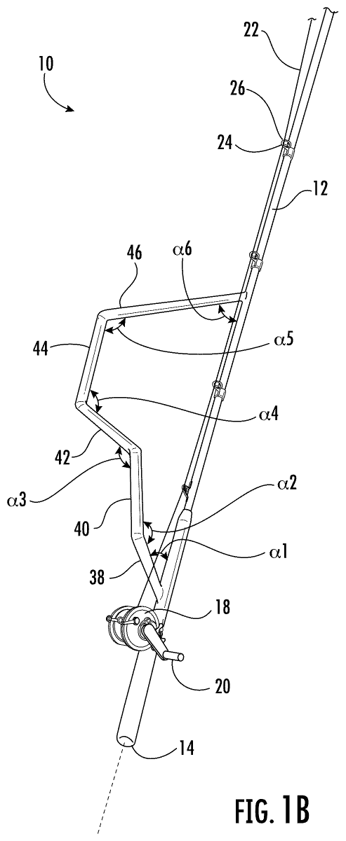

Embodiments of the invention are directed towards a device for use in fishing designed to provide a user multiple hand positions, thus offering multiple leverage segments when reeling in a fish, see FIGS. 1-18. The device, referred to generally as a fishing device with multiple leverage segments 10, may be integrally formed as part of a fishing rod or fishing pole, or may be an attachment which secures to a fishing instrument, such as a fishing rod or fishing pole.

Referring specifically to FIG. 1A, an embodiment of the fishing device with multiple leverage segments 10 comprises an elongated body 12, such as a fishing rod made of, for example, wood, fiberglass, or carbon fiber, comprising a first end 14 and a second, opposing end 16. A casting reel 18 with a handle 20 secures to a portion of the elongated body 12. Fishing line (a flexible, high-tensile cord) 22 is secured to the casting reel 18 and extends outwardly along the length of the elongated body 12, towards the second end 16. A plurality of guide rings 24 may be spaced apart and arranged along the elongated body 12. The guide rings (or o-ring) 24 may be sized and shaped to receive and hold the fishing line 22 through the ring opening 26.

Integrally formed form or attached to the elongated body 12 is a leveraging member 28 (also referred to as a leveraging unit), thus forming a leveraging section defining multiple areas that a user may grab. The leveraging member 28 includes a leveraging member body 30 comprising one or more segments, formed by one or more bends, one or more curves, one or more angles, or combinations thereof, creating an irregular (non-linear) overall shape. The length and shape of the leveraging member 28 creates multiple leverage segments along the elongated body 12.

The leveraging member 28 extends away from the elongated body 12 in an off-set orientation or off-center position. In this position, the leveraging member body 28 is positioned (extends out or away from) a distance from a center, longitudinal axis 32 of the elongated body 12. From the first point of contact 34 with the elongated body 12 to a second point of contact 36 with the elongated body 12, the leveraging member 28 provides multiple leverage points which a user can grab or rest their hand thereon. As illustrated in FIG. 1A, the leveraging member 28 includes five leverage segments, leverage segment 38, leverage segment 40, leverage segment 42, leverage segment 44, and leverage segment 46.

Referring to FIG. 1B, the five leverage segments, leverage segment 38, leverage segment 40, leverage segment 42, leverage segment 44, and leverage segment 46, are shown having various lengths. £ Leverage segment 46 has the longest length, while leverage area 38 has the shortest length.

The five leverage segments, leverage segment 38, leverage segment 40, leverage segment 42, leverage segment 44, and leverage segment 46, are shown having various degrees of angulation relative to each other (adjacent segment) or the main body 12. Leverage segment 38 diverges from the main body 12 at an angle, α₁. The angle, α₁, may be from greater than zero degrees (0°) to less than one-hundred eighty degrees (180°) or from greater than zero degrees (0°) to less than three-hundred and sixty degrees (360°). Leverage area 40 diverges from the leverage segment 38 at an angle, α₂. The angle, α₂, may be from greater than zero degrees (0) to less than one-hundred eighty degrees (180°) or from greater than zero degrees (0°) to less than three-hundred and sixty degrees (360°). Leverage segment 42 diverges from leverage segment 40 at an angle, α₃. The angle, α₃, may be from greater than zero degrees (0°) to less than one-hundred eighty degrees (180°) or from greater than zero degrees (0°) to less than three-hundred and sixty degrees (360°). Leverage segment 44 diverges from the leverage segment 42 at an angle, α₄. The angle, α₄, may be from greater than zero degrees (0°) to less than one-hundred eighty degrees (180°) or from greater than zero degrees (0°) to less than three-hundred and sixty degrees (360°). Leverage segment 46 diverges from the leverage segment 44 at an angle, α₅. The angle, α₅, may be from greater than zero degrees (0°) to less than one-hundred eighty degrees (180°) or from greater than zero degrees (0°) to less than three-hundred and sixty degrees (360°). Leverage segment 46 diverges from the elongated body 12 at an angle, α₆. The angle, α₆, may be from greater than zero degrees (0°) to less than one-hundred eighty degrees (180°) or from greater than zero degrees (0°) to less than three-hundred and sixty degrees (360°).

The leveraging member 28, and therefore each of the leverage segments, leverage segment 38, leverage segment 40, leverage segment 42, leverage segment 44, and leverage segment 46 may be solid. Alternatively, the leveraging member 28, and therefore each of the leverage segments, leverage segment 38, leverage segment 40, leverage segment 42, leverage segment 44, and leverage segment 46 may be hollow or partially hollow. In some embodiments, the leveraging member 28, and therefore each of the leverage segments, leverage segment 38, leverage segment 40, leverage segment 42, leverage segment 44, and leverage segment 46 may be a combination of solid and hollow or partially hollow segments.

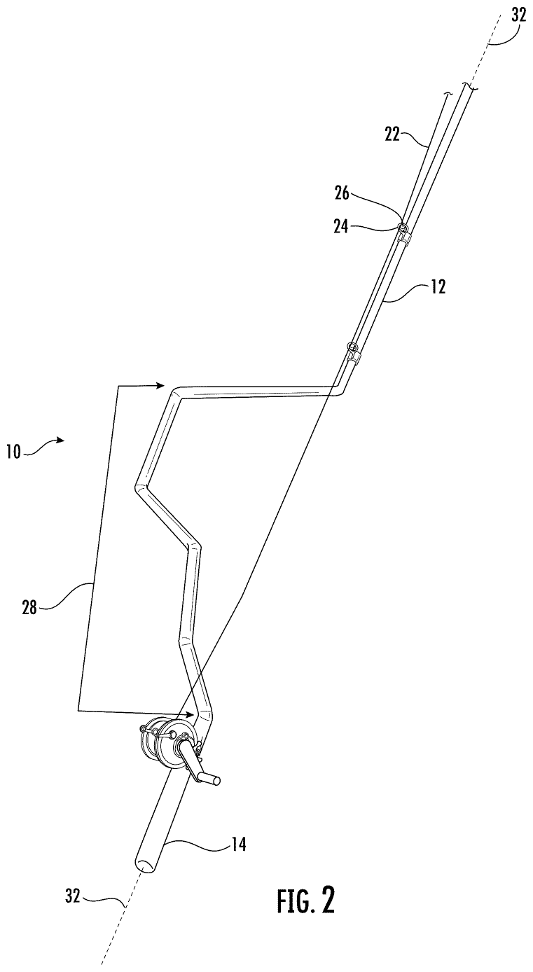

Referring to FIG. 2, the fishing device with multiple leverage segments 10 is shown in an embodiment with a portion of the main body, specifically, the section of the main body where the leveraging member 28 begins and ends, removed.

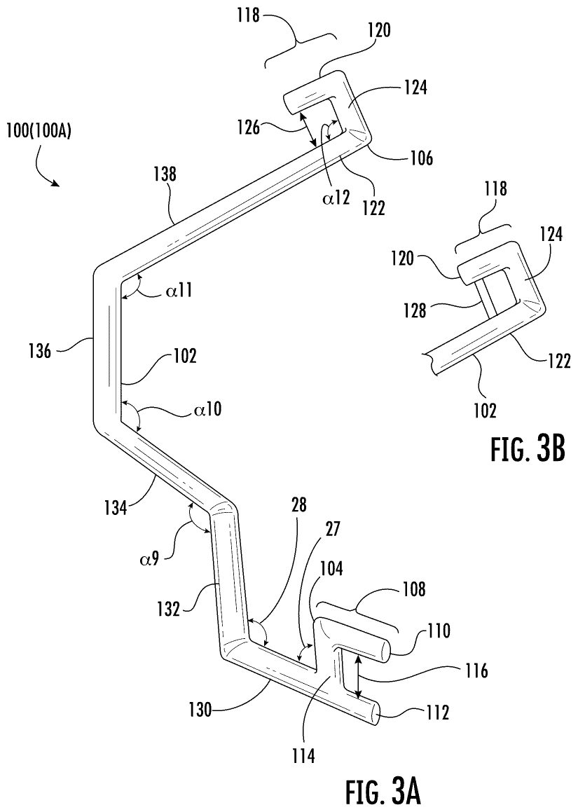

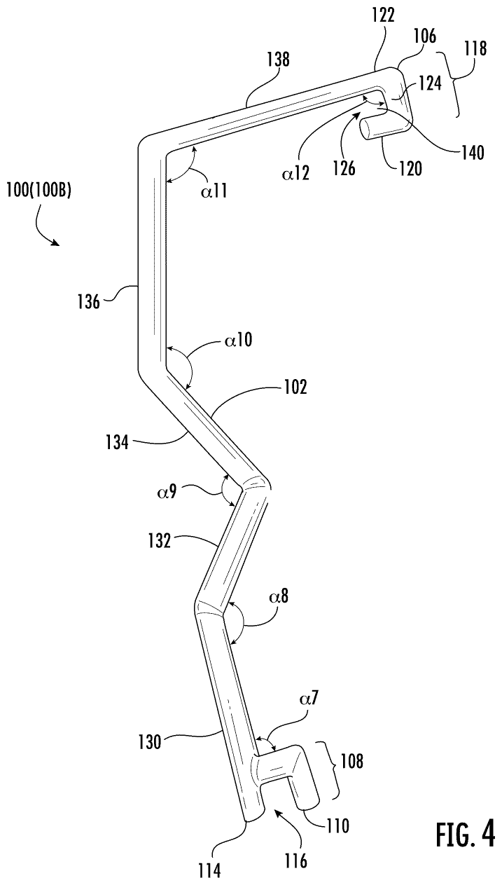

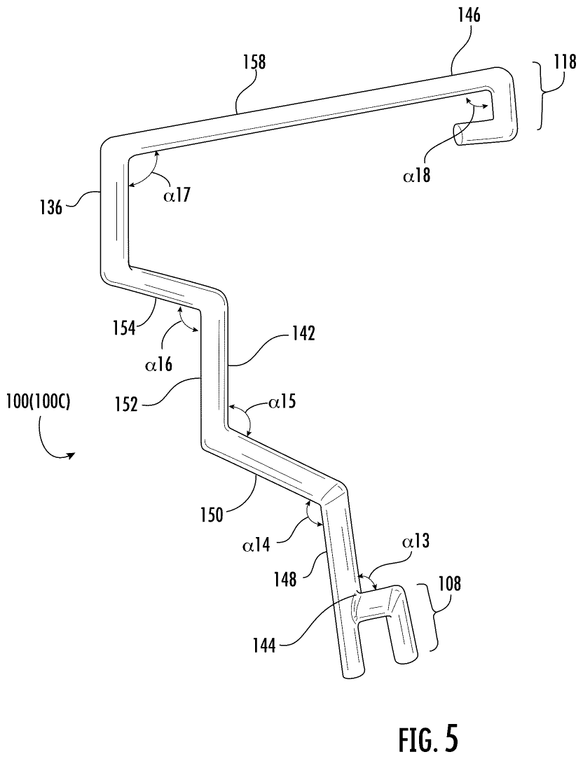

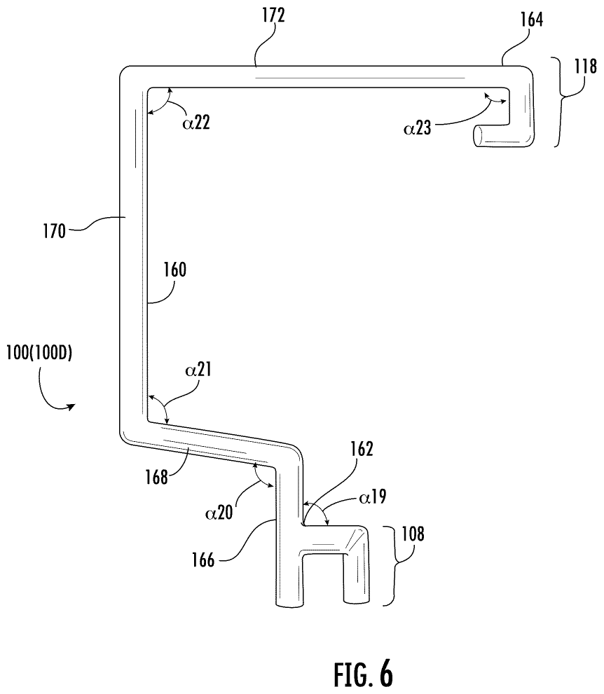

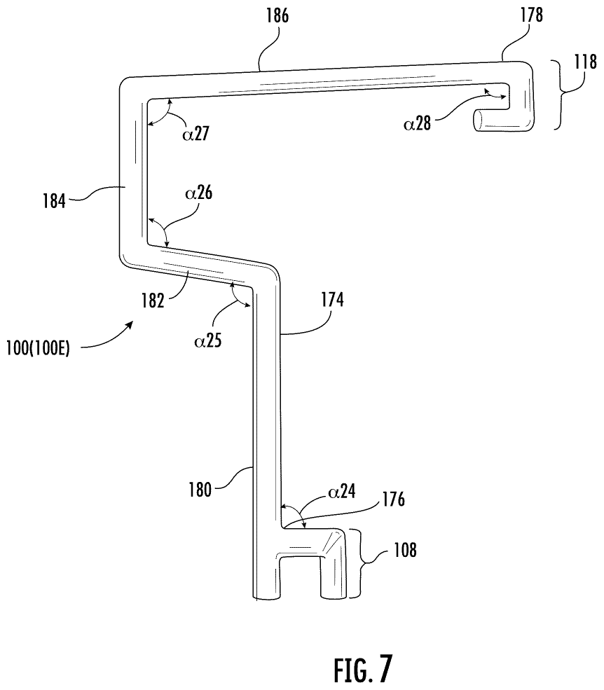

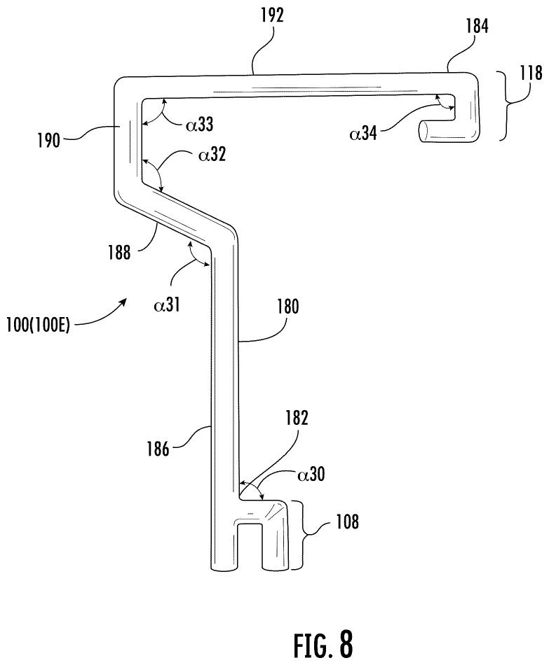

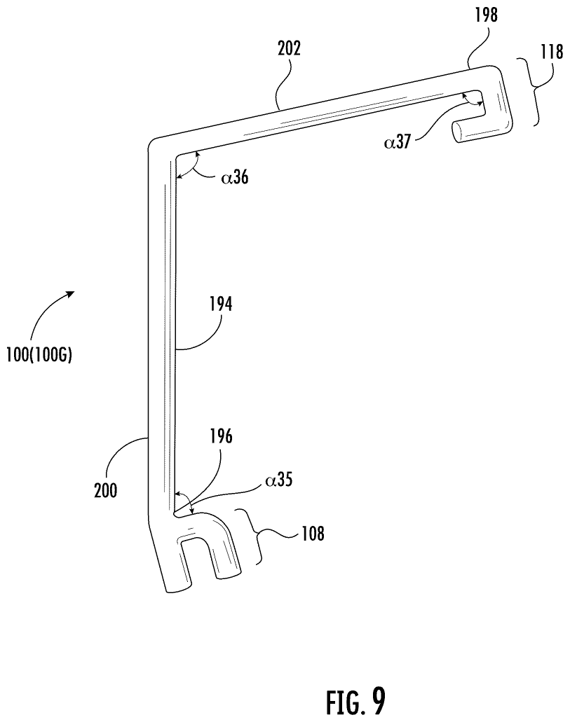

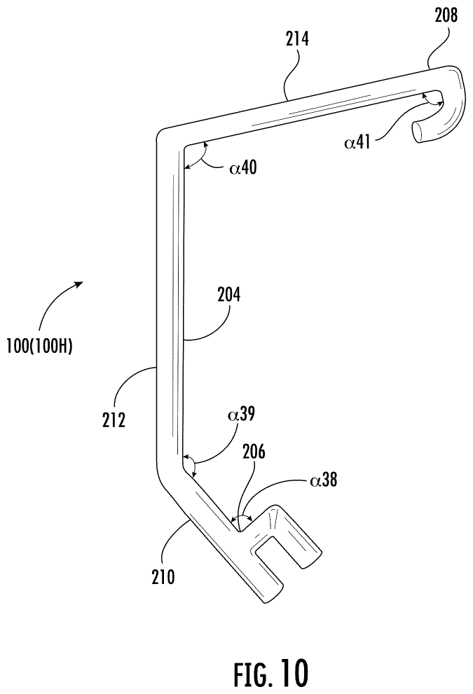

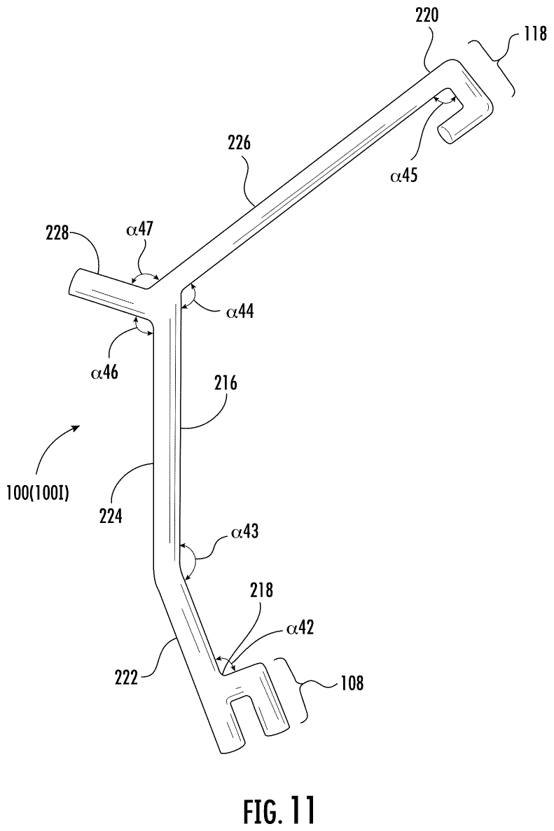

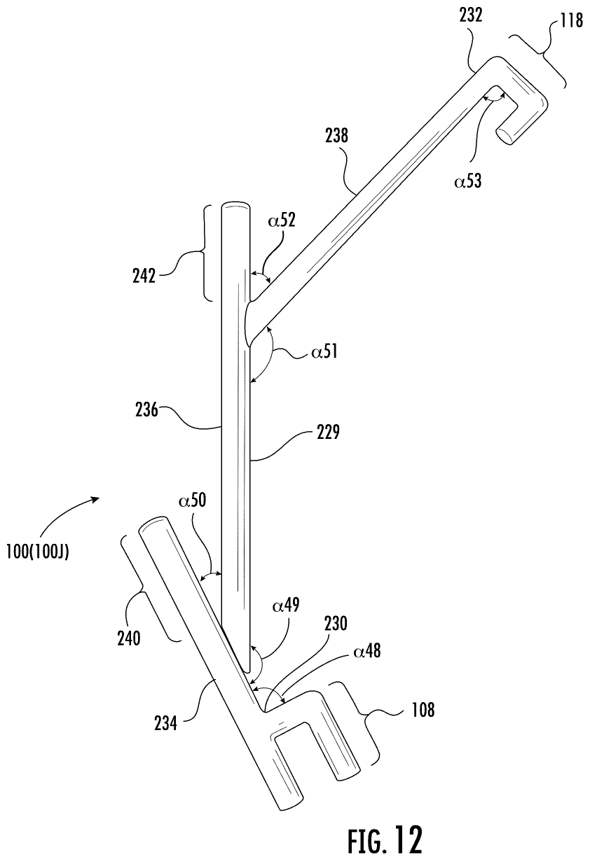

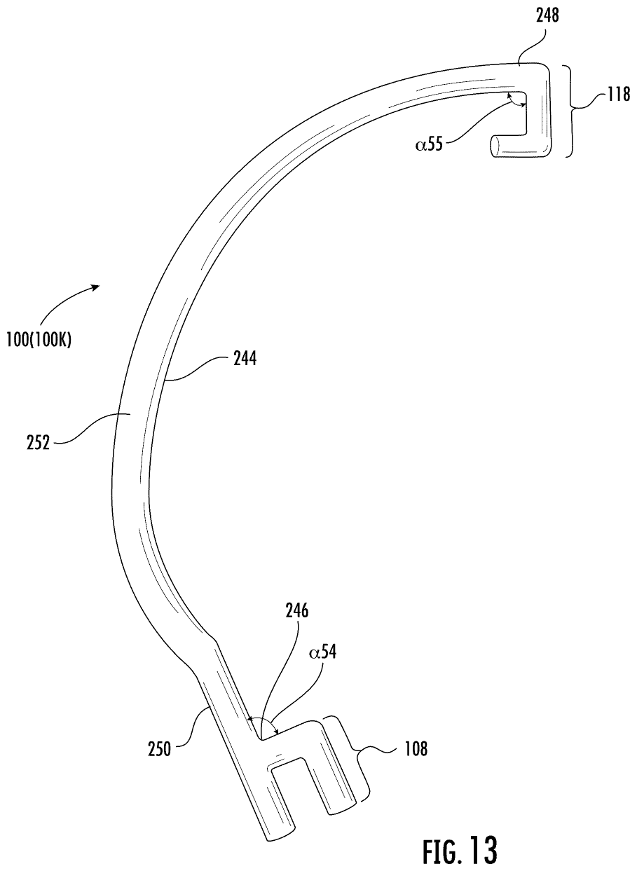

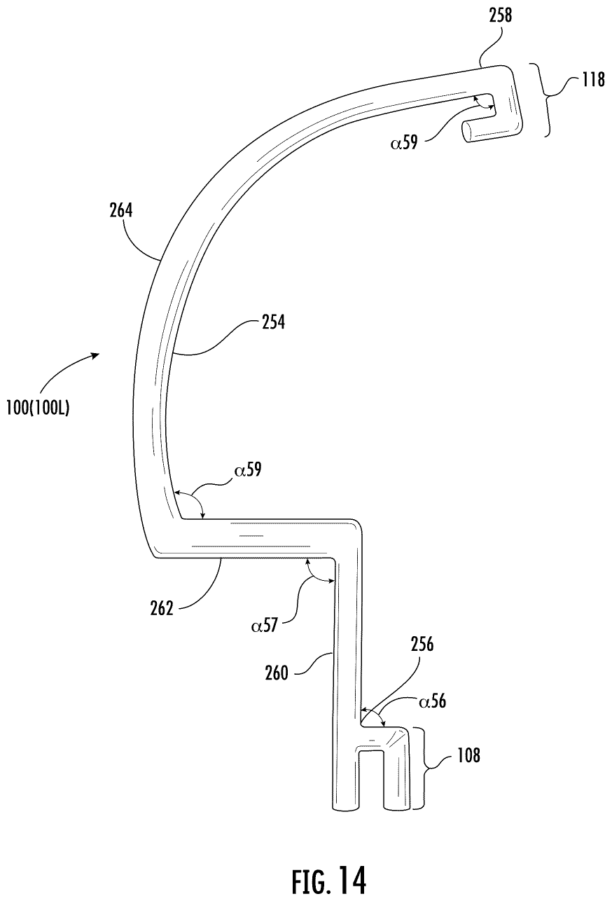

Referring to FIGS. 3-14, the embodiment of the fishing device with multiple leverage segments, referred to generally as the fishing device with multiple leverage segments 100 (may also be also referred to as a leveraging unit; and individually as 100A, see FIG. 3A; 100B, see FIG. 4; 100C, see FIG. 5; 100D, see FIG. 6; 100E, see FIG. 7; 100F, see FIG. 8; 100G, see FIG. 9; 100H, see FIG. 10; 100I, see FIG. 11; 100J, see FIG. 12; 100K, see FIGS. 13 and 100L, see FIG. 14), is illustrated as an independent structure which is added and/or secured to a fishing instrument, such as a fishing rod or fishing pole. While shown as an add-on structures, the configurations described may be used as the leveraging member 28. Each of the embodiments is constructed and arranged to secure to two different sections of a fishing device. For illustrative purposes in describing the structural features of the fishing device with multiple leverage segments 100, the fishing instrument is described as a fishing rod. Each of the individual embodiments, 100A, 100B, 100C, 100D, 100E, 100F, 100G, 100H, 100I, 100J, 100K, and 100L, function in the same manner, differing in the number, size, shape, orientation, or angular degrees of divergence of the leverage segments.

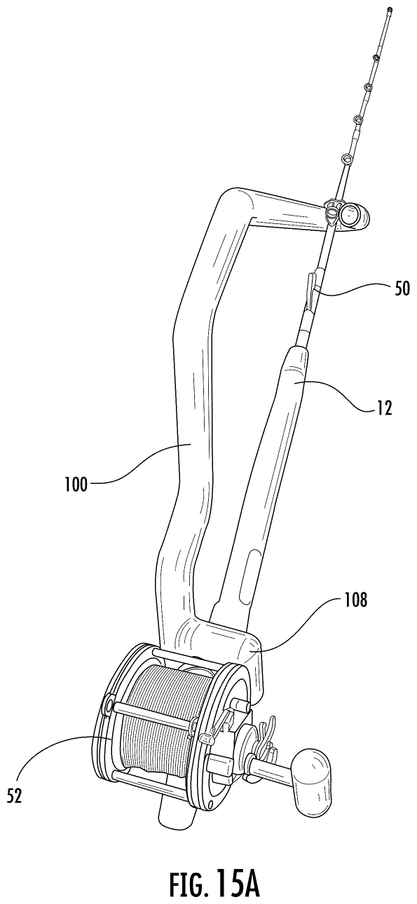

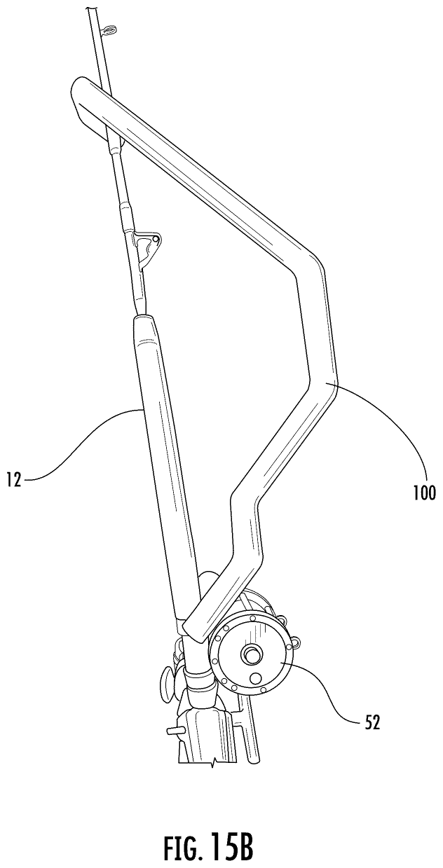

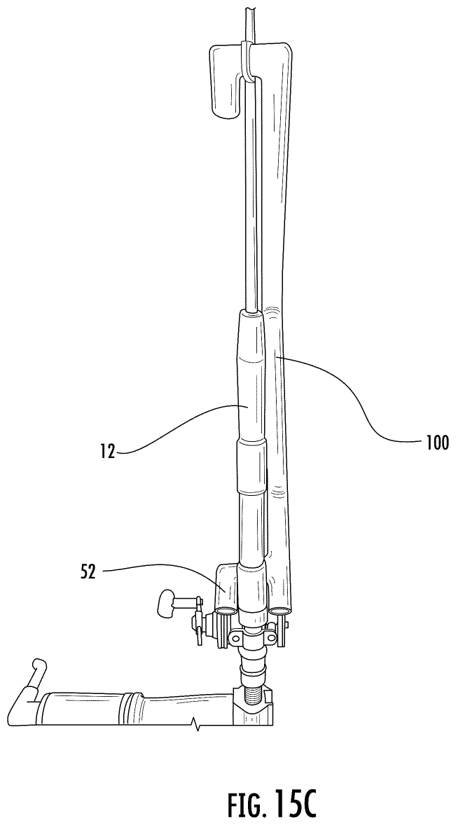

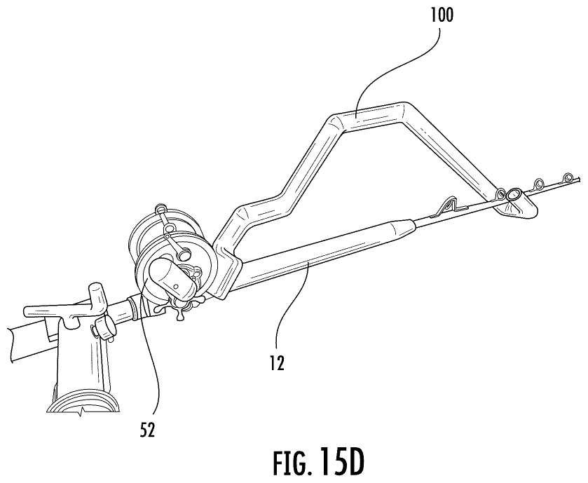

Referring to FIG. 3A, the fishing device with multiple leverage segments 100, referred to as fishing device with multiple leverage segments 100A, is shown having a main body 102 having a first end 104 and a second end 106. The first end 104, which engages with and/or secures to a fishing rod 50 (see FIG. 15A; FIGS. 15B-15D illustrating alternative views) at the reel end, comprises a first fishing device engagement member 108. The first fishing device engagement member 108 engages with and/or secures to a first section or portion of the fishing rod and comprises a first elongated member or arm 110 and a second elongated member or arm 112. The first elongated member or arm 110 connects to the second elongated member or arm 112 by a horizontally orientated bridging member 114, thus assuming an inverted, generally U-shaped structure having an open end. The bridging member 114 has a length that separates the first elongated member or arm 110 from the second elongated member or arm 112 by a gap or space 116.

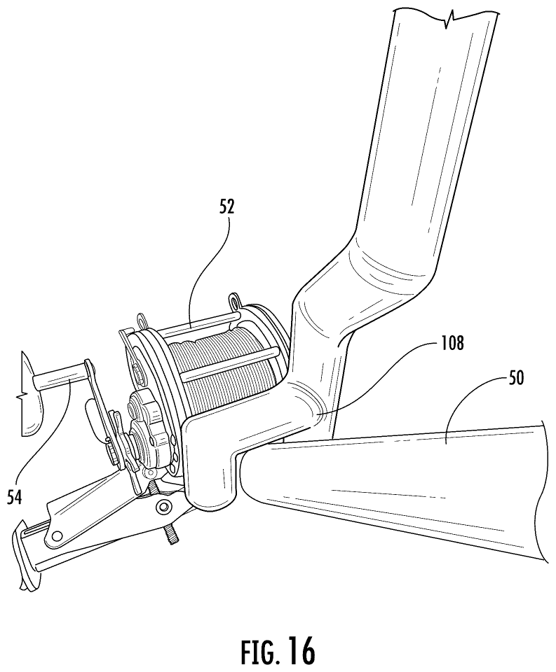

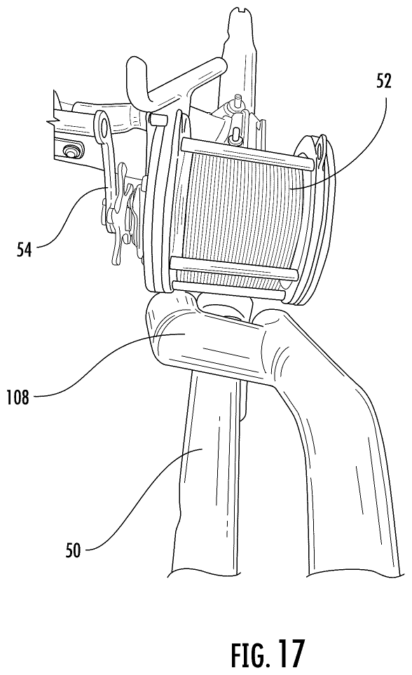

The first fishing device engagement member 108 may be arranged in an off-set position, with at least a portion being off-center relative to an adjacent segment of the main body 102. The off-set orientation is designed to position the main body 102 to be off-center and to the opposite side of the reel 52 and reel handle 54, see FIGS. 16 and 17, thus preventing interference with the fishing line as the line leaves the reel and travels through the guide rings 24, illustrated as eyelets of the fishing rod. Although the first fishing device engagement member 108 is shown assuming a generally U-shaped configuration, other configurations, such as but not limited to V-shape configurations or C-shape configurations, may be used. In use, the first fishing device engagement member 108 is placed over and down on the reel where it meets the rod, thus providing a fulcrum point, see FIGS. 16 and 17.

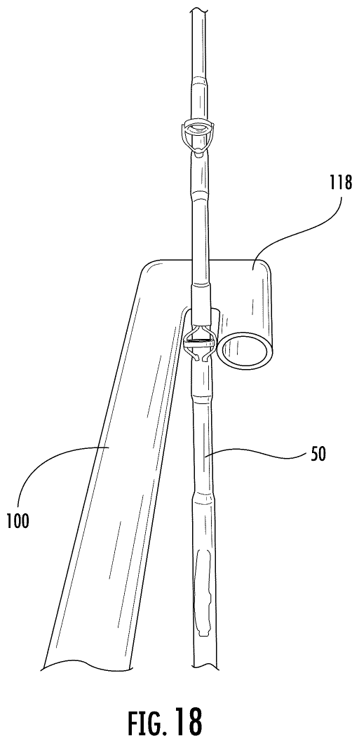

The second end 106 of the main body 102, which engages with and/or secures to the fishing hook end of the fishing rod (see FIG. 18) comprises a second fishing device engagement member 118. The second fishing device engagement member 118 engages with and/or secures to a second section or portion of the fishing rod, with the second section or portion the fishing rod being different than the first section or portion of the fishing rod. The second fishing device engagement member 118 may comprise a first elongated member or arm 120 and a second elongated member or arm 122. The first elongated member or arm 120 connects to the second elongated member or arm 122 by a horizontally orientated bridging member 124, thus assuming an inverted, generally U-shaped structure having an open end. The bridging member 124 has a length that separates the first elongated member or arm 120 from the second elongated member or arm 122 by a gap or space 126. Optionally, a clip 128, see FIG. 3B, may be placed in the gap 126 to hold the second fishing device engagement member 118 in place.

The second fishing device engagement member 118 may be arranged in an off-set position, with at least a portion being off-center relative to an adjacent segment of the leverage section body 102. The off-set orientation is designed to position the main body 102 to be off-center and to the opposite side of the reel handle, see FIGS. 16 and 17, thus preventing interference with the fishing line as the line leaves the reel and travels through the guide rings 24 of the fishing rod. Although the first fishing device engagement member 118 is shown assuming a generally U-shaped configuration, other configurations, such as but not limited to V-shape configurations or C-shape configurations, may be used.

The leverage section body 102 is comprised of five (5) leverage segments (similar to leverage segment 38, leverage segment 40, leverage segment 42, leverage segment 44, and leverage segment 46 described in FIG. 1 for the fishing device with multiple leverage segments 10). The leverage segments include leverage segment 130, leverage segment 132, leverage segment 134, leverage segment 136, and leverage segment 138. Each of the leverage segments 130, 132, 134, 136 and 138 are oriented or positioned from adjacent leverage segments by a bend or curve defined by angle.

The leverage segment 130 diverges from the first fishing device engagement member 108 at an angle, α₇. The angle, α₇, may be from greater than zero degrees (0°) to less than one-hundred eighty degrees (180°) or from greater than zero degrees (0°) to less than three-hundred and sixty degrees (360°). The leverage segment 132 diverges from the leverage area 130 at an angle, as. The angle, α₈, may be from greater than zero degrees (0°) to less than one-hundred eighty degrees (180°) or from greater than zero degrees (0°) to less than three-hundred and sixty degrees (360°). The leverage segment 134 diverges from the leverage area 132 at an angle, α₉. The angle, do, may be from greater than zero degrees (0°) to less than one-hundred eighty degrees (180°) or from greater than zero degrees (0°) to less than three-hundred and sixty degrees (360°). The leverage segment 136 diverges from the leverage segment 134 at an angle, α₁₀. The angle, α₁₀, may be from greater than zero degrees (0°) to less than one-hundred eighty degrees (180°) or from greater than zero degrees (0°) to less than three-hundred and sixty degrees (360°). The leverage segment 138 diverges from the leverage segment 136 at an angle, α₁₁. The angle, α₁₁, may be from greater than zero degrees (0°) to less than one-hundred eighty degrees (180°) or from greater than zero degrees (0°) to less than three-hundred and sixty degrees (360°). The leverage segment 138 diverges from the second fishing device engagement member 118 at an angle, α₁₂. The angle, α₁₂, may be from greater than zero degrees (0°) to less than one-hundred eighty degrees (180°) or from greater than zero degrees (0°) to less than three-hundred and sixty degrees (360°).

In use, the first fishing device engagement member 108 is placed over and down on the reel where it meets the rod, this providing a fulcrum point, see FIGS. 16 and 17. Once the fishing device with multiple leverage segments 100A is secured to the fishing rod at both ends, it provides the user multiple hand positions, allowing the user to pull the fishing rod towards them with much greater leverage than a standard fishing rod. The hand position of the user would depend on the angle of the fishing rod at the moment. The fishing device with multiple leverage segments 100A makes it easier to reel in a fish by creating more leverage when pulling the rod towards the user before letting it out to reel in more line.

FIG. 4 illustrates an embodiment of the fishing device with multiple leverage segments 100, referred to specifically as the fishing device with multiple leverage segments 100B. The fishing device with multiple leverage segments 100B comprises the same structural components as that described for the fishing device with multiple leverage segments 100A, differing mostly in the arrangement, orientation, and/or the degrees of angulation (α₇, α₈, α₉, α₁₀, α₁₁ or α₁₂) between adjacent leverage segments 130, 132, 134, 136, and 138. Additionally, the orientation of the second fishing device engagement member 118 is reversed, oriented inwardly or towards the first fishing device engagement member 108. The second fishing device engagement member 118 includes a more rounded surface edge 140 compared to the same structure in the fishing device with multiple leverage segments 100A.

FIG. 5 illustrates an embodiment of the fishing device with multiple leverage segments 100, referred to specifically as the fishing device with multiple leverage segments 100C. The fishing device with multiple leverage segments 100C comprises a main body 142 having a first end 144 and a second end 146, the first fishing device engagement member 108, and the second fishing device engagement member 118. The main body 142 comprises six (6) leverage segments, leverage segment 148, leverage segment 150, leverage segment 152, leverage segment 154, leverage segment 156, and leverage segment 158. Each of the leverage segments 148, 150, 152, 154, 156, and 158 diverge from an adjacent leverage segment, the first fishing device engagement member 108, or the second fishing device engagement member 118 by an angle, α₁₃, α₁₄, α₁₅, α₁₆, α₁₇, and α₁₈. Each angle, α₁₃, α₁₄, α₁₅, α₁₆, α₁₇, and α₁₈ may be from greater than zero degrees (0°) to less than one-hundred eighty degrees (180°) or from greater than zero degrees (0°) to less than three-hundred and sixty degrees (360°).

FIG. 6 illustrates an embodiment of the fishing device with multiple leverage segments 100, referred to specifically as the fishing device with multiple leverage segments 100D. The fishing device with multiple leverage segments 100D comprises a main body 160 having a first end 162 and a second end 164, the first fishing device engagement member 108, and the second fishing device engagement member 118. The main body 162 comprises four (4) leverage segments, leverage segment 166, leverage segment 168, leverage segment 170, and leverage segment 172. Each of the leverage segments 166, 168, 170, and 172 diverge from an adjacent leverage segment, the first fishing device engagement member 108, or the second fishing device engagement member 118 by an angle, (α₁₉, α₂₀, α₂₁, α₂₂ and α₂₃. Each angle, α₁₉, α₂₀, α₂₁, α₂₂ and α₂₃ may be from greater than zero degrees (0°) to less than one-hundred eighty degrees (180°) or from greater than zero degrees (0°) to less than three-hundred and sixty degrees (360°).

FIG. 7 illustrates an embodiment of the fishing device with multiple leverage segments 100, referred to specifically as the fishing device with multiple leverage segments 100E. The fishing device with multiple leverage segments 100E comprises a main body 174 having a first end 176 and a second end 178, the first fishing device engagement member 108, and the second fishing device engagement member 118. The main body 174 comprises four (4) leverage segments, leverage segment 180, leverage segment 182, leverage segment 184, and leverage segment 186. Each of the leverage segments 180, 182, 184, and 186 diverge from an adjacent leverage segment, the first fishing device engagement member 108, or the second fishing device engagement member 118 by an angle, α₂₄, α₂₅, α₂₆, α₂₆₇ and α₂₈. Each angle, α₂₄, α₂₅, α₂₆, α₂₆₇ and α₂₈ may be from greater than zero degrees (0°) to less than one-hundred eighty degrees (180°) or from greater than zero degrees (0°) to less than three-hundred and sixty degrees (360°).

FIG. 8 illustrates an embodiment of the fishing device with multiple leverage segments 100, referred to specifically as the fishing device with multiple leverage segments 100F. The fishing device with multiple leverage segments 100F comprises a main body 180 having a first end 182 and a second end 184, the first fishing device engagement member 108, and the second fishing device engagement member 118. The main body 180 comprises four (4) leverage segments, leverage segment 186, leverage segment 188, leverage segment 190, and leverage segment 192. Each of the leverage segment 186, 188, 190, and 192 diverge from an adjacent leverage segment, the first fishing device engagement member 108, or the second fishing device engagement member 118 by an angle, α₃₀, α₃₁, α₃₂, α₃₃ and α₃₄. Each angle, α₃₀, α₃₁, α₃₂, α₃₃ and α₃₄, may be from greater than zero degrees (0) to less than one-hundred eighty degrees (180°) or from greater than zero degrees (0°) to less than three-hundred and sixty degrees (360°).

FIG. 9 illustrates an embodiment of the fishing device with multiple leverage segments 100, referred to specifically as the fishing device with multiple leverage segments 100G. The fishing device with multiple leverage segments 100G comprises a main body 194 having a first end 196 and a second end 198, the first fishing device engagement member 108, and the second fishing device engagement member 118. The main body 180 comprises two (2) leverage segments, leverage segment 200 and leverage segment 202. Each of the leverage segments 200 and 202 diverge from an adjacent leverage segment, the first fishing device engagement member 108, or the second fishing device engagement member 118 by an angle, α₃₅, α₃₆, and α₃₇. Each angle, α₃₅, α₃₆, and α₃₇, may be from greater than zero degrees (0°) to less than one-hundred eighty degrees (180°) or from greater than zero degrees (0°) to less than three-hundred and sixty degrees (360°).

FIG. 10 illustrates an embodiment of the fishing device with multiple leverage segments 100, referred to specifically as the fishing device with multiple leverage segments 100H. The fishing device with multiple leverage segments 100H comprises a main body 204 having a first end 206, a second end 208, the first fishing device engagement member 108, and the second fishing device engagement member 118. The main body 204 comprises three (3) leverage segments, leverage segment 210, leverage segment 212, and leverage segment 214. Each of the leverage segments 210, 212 and 214 diverge from an adjacent leverage area, the first fishing device engagement member 108, or the second fishing device engagement member 118 by an angle, α₃₈, α₃₉, α₄₀, and α₄₁. Each angle, α₃₈, α₃₉, α₄₀, and α₄₁ may be from greater than zero degrees (0°) to less than one-hundred eighty degrees (180°) or from greater than zero degrees (0°) to less than three-hundred and sixty degrees (360°).

FIG. 11 illustrates an embodiment of the fishing device with multiple leverage segments 100, referred to specifically as the fishing device with multiple leverage segments 100I. The fishing device with multiple leverage Segments 100I comprises a main body 216 having a first end 218, a second end 220, the first fishing device engagement member 108, and the second fishing device engagement member 118. The main body 216 comprises three (3) leverage segments, leverage segment 222, leverage segment 224, and leverage segment 226. A fourth leverage segment 228 extends outwardly and away from the main body 216. Each of the leverage segments 222, 224 and 226 diverge from an adjacent leverage segment, the first fishing device engagement member 108, or the second fishing device engagement member 118 by an angle, α₄₂, α₄₃, α₄₄, and α₄₅. Each angle, α₄₂, α₄₃, α₄₄, and α₄₅ may be from greater than zero degrees (0°) to less than one-hundred eighty degrees (180°) or from greater than zero degrees (0°) to less than three-hundred and sixty degrees (360°). The fourth leverage segment 228 diverges from leverage segment 224 or leverage segment 226 by an angle α₄₆ and/or α₄₇. Each angle, α₄₆ and/or α₄₇ may be from greater than zero degrees (0) to less than one-hundred eighty degrees (180°) or from greater than zero degrees (0°) to less than three-hundred and sixty degrees (360°).

FIG. 12 illustrates an embodiment of the fishing device with multiple leverage segments 100, referred to specifically as the fishing device with multiple leverage segments 100J. The fishing device with multiple leverage segments 100J comprises a main body 229 having a first end 230, a second end 232, the first fishing device engagement member 108, and the second fishing device engagement member 118. The main body 229 comprises three (3) leverage segments, leverage segment 234, leverage segment 236, and leverage segment 238. Unlike the previously described fishing device with multiple leverage segments 100A-100H, where the adjacent leverage segments diverge from each other at an end/beginning of the segment, leverage segment 234, leverage segment 236, and leverage segment 238 diverge in an area that is not the end/beginning. This arrangement results in portions 240, 242 of leverage segment 234 and leverage segment 236 to extend past the point of divergence. Each of the leverage segments 234, 236 and 238 diverge from an adjacent leverage segment, the first fishing device engagement member 108, or the second fishing device engagement member 118 by an angle, α₄₈, α₄₉, α₅₀, α₅₁, α₅₂, and α₅₃. Each angle, α₄₈, α₄₉, α₅₀, α₅₁, α₅₂, and α₅₃, may be from greater than zero degrees (0°) to less than one-hundred eighty degrees (180°) or from greater than zero degrees (0°) to less than three-hundred and sixty degrees (360°).

FIG. 13 illustrates an embodiment of the fishing device with multiple leverage segments 100, referred to specifically as the fishing device with multiple leverage segments 100K. The fishing device with multiple leverage segments 100K comprises a main body 244 having a first end 246, a second end 248, the first fishing device engagement member 108, and the second fishing device engagement member 118. The main body 244 comprises two (2) leverage segments, leverage segment 250 and leverage segment 252. The leverage segment 250 generally assumes a linear shape, while the leverage segment 252 assumes a curved or partially curved shape. Each of leverage segment 250 and leverage segment 252 diverge from an adjacent leverage segment, the first fishing device engagement member 108, or the second fishing device engagement member 118 by an angle, α₅₄ or α₅₅. Each angle, α₅₄ or α₅₅, may be from greater than zero degrees (0°) to less than one-hundred eighty degrees (180°) or from greater than zero degrees (0°) to less than three-hundred and sixty degrees (360°).

FIG. 14 illustrates an embodiment of the fishing device with multiple leverage segments 100, referred to specifically as the fishing device with multiple leverage segments 100L. The fishing device with multiple leverage segments 100L comprises a main body 254 having a first end 256, a second end 258, the first fishing device engagement member 108, and the second fishing device engagement member 118. The main body 254 comprises three (3) leverage segments, leverage segment 260, leverage segment 262, and leverage segment 264. The leverage segments 260 and 262 generally assume a linear shape, while the leverage segment 264 assumes a curved or partially curved shape. Each of the leverage segments, leverage segment 260, leverage segment 262, and leverage segment 264, diverge from an adjacent leverage segment, the first fishing device engagement member 108, or the second fishing device engagement member 118 by an angle, α₅₆, α₅₇, α₅₈ or α₅₉. Each angle, α₅₆, α₅₇, α₅₈ or α₅₉, may be from greater than zero degrees (0°) to less than one-hundred eighty degrees (180°) or from greater than zero degrees (0°) to less than three-hundred and sixty degrees (360°).

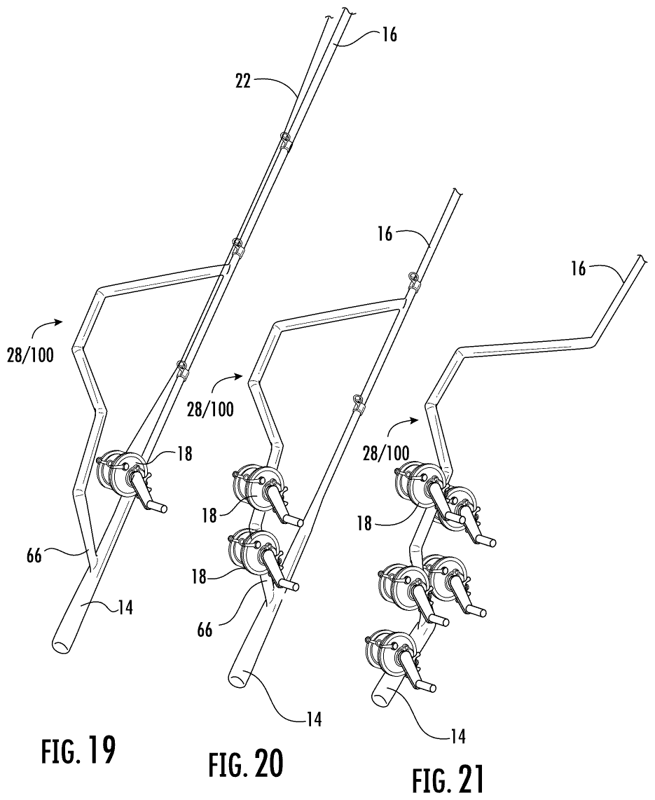

Referring to FIGS. 19-21, the fishing reel (casting reel 18) may be placed and mounted in various locations. For example, the casting reel 18 may be placed/mounted (on the pole 12) forward or upward (away from the handle/first end and towards second end 16) of the base 66 of the leverage unit 28/100, see FIG. 19. As with any configuration, the fishing line 22 may be routed through holes in the rod itself acting as an eyelet or with the reel 18 tilted to the side making the line by-pass the rod and go through the stranded eyelet. Referring to FIG. 20, the reel 18 is shown being placed/mounted on various segments of the leverage unit 28/100. The reel 18 may be placed and mounted on any portion of the leverage unit 28/100, with or without the straight support portion. FIG. 20 illustrates alternative placement/securement of the reel 18, shown be placed/secured to at various segments of the leverage unit 28/100 or on various sides of a segment.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures, and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A fishing device comprising:
an elongated pole or rod; and
a leverage unit, said leverage unit comprising multiple leverage points which a user can grab or rest their hand thereon, said leverage unit off-set from said longitudinal axis of said elongated pole or rod.

2. The fishing device according to claim 1, wherein said leverage unit comprises a plurality of segments sized and shaped for gripping.

3. The fishing device according to claim 1, wherein said leverage unit comprises a plurality of adjacent segments or surfaces wherein each adjacent segment is oriented in different direction.

4. The fishing device according to claim 3, wherein each adjacent segment is separated by an angle.

5. The fishing device according to claim 4, wherein said angle of separation is between greater than zero degrees (0°) to less than three-hundred and sixty degrees (360°).

6. The fishing device according to claim 4, wherein said angle of separation is between greater than zero degrees (0°) and less than one-hundred eighty degrees (180°).

7. The fishing device according to claim 1, further including a fishing reel.

8. The fishing device according to claim 7, wherein said fishing reel is positioned about said elongated pole or rod forward off or behind said leverage unit.

9. The fishing device according to claim 7, wherein said fishing reel is positioned on said leverage unit.

10. The fishing device according to claim 1, wherein leverage unit comprises a curved surface.

11. A leverage device for attaching to a fishing pole or rod, comprising:
a first end having a first fishing device engagement member;
a second end having a second fishing device engagement member; and
a body separating said first end and said second end, said body comprising multiple leverage points which a user can grab or rest their hand thereon.

12. The leverage device according to claim 11, wherein said body comprises a plurality of segments or surfaces.

13. The leverage device according to claim 11, wherein said body comprises multiple adjacent segments, wherein said multiple adjacent segments are separated by an angle.

14. The leverage device according to claim 13, wherein said angle of separation is between greater than zero degrees (0°) to less than three-hundred and sixty degrees (360°).

15. The leverage device according to claim 13, wherein said angle of separation is between greater than zero degrees (0°) and less than one-hundred eighty degrees (180°).

16. The leverage device according to claim 11 wherein,
said first fishing device engagement member secures to a first section of a fishing rod; and
said second fishing device engagement member secures to a second section of a fishing rod,
wherein said second section of the fishing rod is different than the first section of the fishing rod.

17. The leverage device according to claim 11, wherein said first fishing device engagement member is constructed and arranged to secure to a fishing pole at or near a fishing pole reel or fishing pole reel handle.

18. The leverage device according to claim 11, wherein body comprises a curved surface.
